(19) United States
(12) Patent Application Publication
(10) Pub. No.: US 2002/0083130 A1
(43) Pub. Date: Jun. 27, 2002

(54) Method and system for referring to data over network

(75) Inventors: Naoki Shimada, Tokyo (JP); Motoaki Hirabayashi, Tokyo (JP); Tsunemasa Uno, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/006,686

(22) Filed: Dec. 10, 2001

(30) Foreign Application Priority Data
Dec. 11, 2000 (JP) 2000-375371

(51) Int. Cl. G06F 15/16

(52) U.S. Cl. 709/203; 709/245

(57) ABSTRACT

The present invention provides a method for referring to data by using the Internet and a storage network in combination and selecting one of the networks to be used depending on the data.

A computer 107 is connected to the Internet 101. A computer 104 is connected to the Internet 101 and a SAN 111. A disk storage 110 is connected to the computer 107 and the SAN 111. A browser 105 requests to a Web server 108 for data over the Internet 101. The Web server 108 sends an error message to the browser 105 in the case where the data address cannot be interpreted. The browser 105 requests to a Web server 106 for the data. The Web server 106 obtains a copy of the YYY image 203 on the disk storage 110 over the SAN 111 to send the copy to the browser 105.

### FIELD OF THE INVENTION

The present invention relates to a method for referring to data over a network and, more particularly, a method for referring to data using the Internet and a storage-computer network such as a SAN in combination.

### BACKGROUND OF THE INVENTION

Referring to a Web page over the Internet or an intranet and downloading a file of a text or a program have diffused universally by now. A Web page in general is described in the form of a file called HTML (HyperText Markup Language) file. A request for a transfer of a Web page is sent to a Web server from a Web browser and the Web server transfers a relevant HTML file retained therein to the Web browser, so that contents of the Web page are displayed on the Web browser in accordance with contents of the HTML file. It is also possible to download a text file or a program file. In this case also, the Web browser requests to the Web server for a transfer of such file to obtain the file. The above requests and file transfers can be made under protocols called HTTP (HyperText Transfer Protocol) or FTP (File Transfer Protocol).

In turn, there is a known technique of structuring a network to be used exclusively for storage by connecting a plurality of computers with a plurality of storages via a fiber channel. Such technique is called Storage Area Network (SAN). For example, Japanese Patent Laid-open No. 2000-99272 discloses the SAN technique.

### SUMMARY OF THE INVENTION

In the case of downloading a large number of files or a large capacity file over the Internet, a transfer of such files, especially of the large capacity file, takes relatively a long time since a large number of data including HTML files and image data is continuously transferred on the Internet. Further, when such large capacity file is transferred over the Internet, a bandwidth of the Internet is reduced to influence considerably on a transfer time of a Web page or the like; thereby delaying the Web page or the like to be displayed. The influence thus caused by the transfer of large capacity file is unignorable since a user usually experiences a display time of a Web page as a response time. Moreover, the display time that drags on during the file transfer exerts a remarkable adverse effect on performance. Conventionally, the following measures are taken under such circumstances: the transfer of large capacity file is performed only once so that the file is stored in a local disk, and then the file is transferred to a nearby computer using a portable medium such as a tape and an optical disk. However, a problem with the conventional method lies in that the method cannot be employed unless the computer is connected to the portable medium.

An object of the present invention is to provide a method and a system for referring to data using the Internet and a storage network in combination and selecting one of the networks as a network to be used depending on the data.

The present invention is characterized by a method for referring to data over a network and a system realizing such method, the method comprising the steps of: requesting data over the Internet by specifying a data address; receiving an error message indicating that the data address cannot be interpreted; requesting the data over a network between a storage and a computer by specifying the data address; and receiving the requested data.

Further, the present invention is characterized by a method for referring to data over a network and a system realizing such method, the method comprising the steps of: judging whether or not requested data are accessible over the Internet from a data address of the data; obtaining the requested data over the Internet if it is judged that the data are accessible over the Internet; requesting the data over a network between a storage and a computer if it is judged that the data are inaccessible over the Internet; and receiving the requested data.

### BRIEF DESCRIPTION OF THE DRAWINGS

FIG. 1 is a diagram showing a general configuration of a system of preferred embodiments;

FIG. 2 shows an example of a Web page displayed on a display screen;

FIG. 3 shows an example of data in HTML file format of the Web page shown in FIG. 2;

FIG. 4 is a flowchart showing a flow of process of a system according to a first embodiment; and

FIG. 5 is a flowchart showing a flow of process of a browser according to a second embodiment.

### DESCRIPTION OF THE PREFERRED EMBODIMENT

Embodiments of the present invention will hereinafter be described in accordance with the attached drawings.

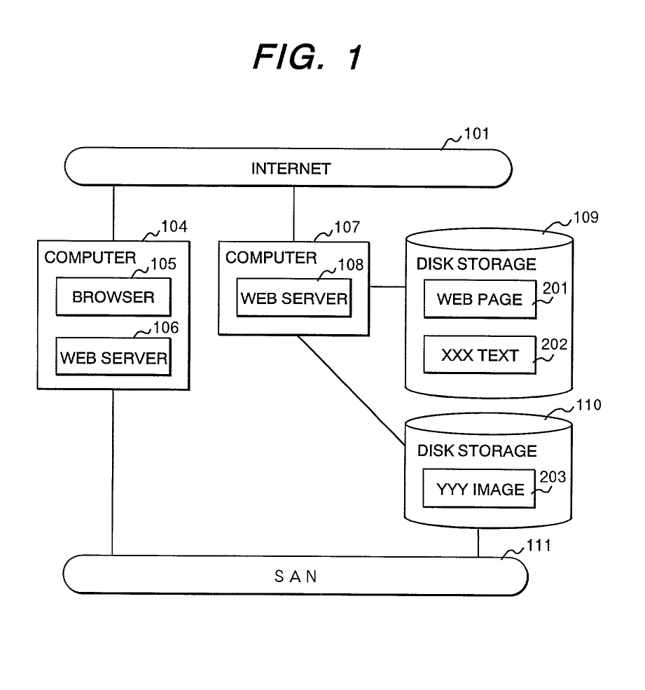

FIG. 1 is a diagram showing a general configuration of the system of the embodiments. Reference numeral 101 denotes the Internet that is a network capable of communication in accordance with an internet protocol. The Internet may be a wide area network or an intranet inside a company. Reference numeral 111 denotes a SAN (Storage Area Network) that is a network for connecting a storage and a computer and comprises a fiber channel and a fiber channel switch. A computer 104 is connected to the Internet 101. The computer 104 is connected also to the SAN 111 via the fiber channel interface. A computer 107 is connected to the Internet 101. The computer 107 is connected also to a disk storage 109 and a disk storage 110. The disk storage 110 is connected to the computer 107 via an input and output interface of the computer 107 as well as to the SAN 111 via the fiber channel interface. Here, a data transmission speed via the SAN 111 is a several times faster than that via the Internet 101.

The disk storage 109 stores files of a Web page 201 and an XXX text 202. It is possible to access the Web page 201 and the XXX text 202 by using data addresses given respectively to the files, each of the data addresses conforming to the HTTP or the FTP. The Internet 101 is suitably used for transferring the Web page 201 and the XXX text 202 considering their storage capacities. The disk storage 110 stores a file of YYY image 203. A data address that cannot be interpreted according to the FTP protocol or the HTTP protocol is used for accessing the YYY image 203, and the SAN 111 is suitably used for transferring the YYY image 203 considering its storage capacity.

The computer 104 stores programs of a browser 105 and a Web server 106 in its memory and executes the programs. The browser 105 is a client means that is loaded on the client computer. The computer 107 stores a program of a Web server 108 in its memory and executes the program. The browser 105 sends a request for a content to the Web server 108 of the computer 107 over the Internet 101 in accordance with a TCP/IP protocol and the HTTP protocol. The Web server 108 accesses the content such as the Web page 201 and the XXX text 202 to send the content requested over the Internet 101 to the browser 105. The browser 105 receives the content and displays the content on a display device of the computer 104. The Web server 108 sends an error message to the browser 105 if a data address that is used in the request for the content cannot be interpreted according to the HTTP protocol or the FTP protocol. The browser 105 receives the error message and requests to a Web server 106 for the content. The Web server 106 accesses the desired content such as the YYY image 203 over the SAN 111 and sends the content to the browser 105. When the browser 105 requests a content, the browser 105 may interpret a data address of the content to decide a Web server that can access the content and request to the Web server for the content. In addition, the browser 105 and the Web server 106 can be loaded separately on different computers, and the computers may be connected via a transmission line.

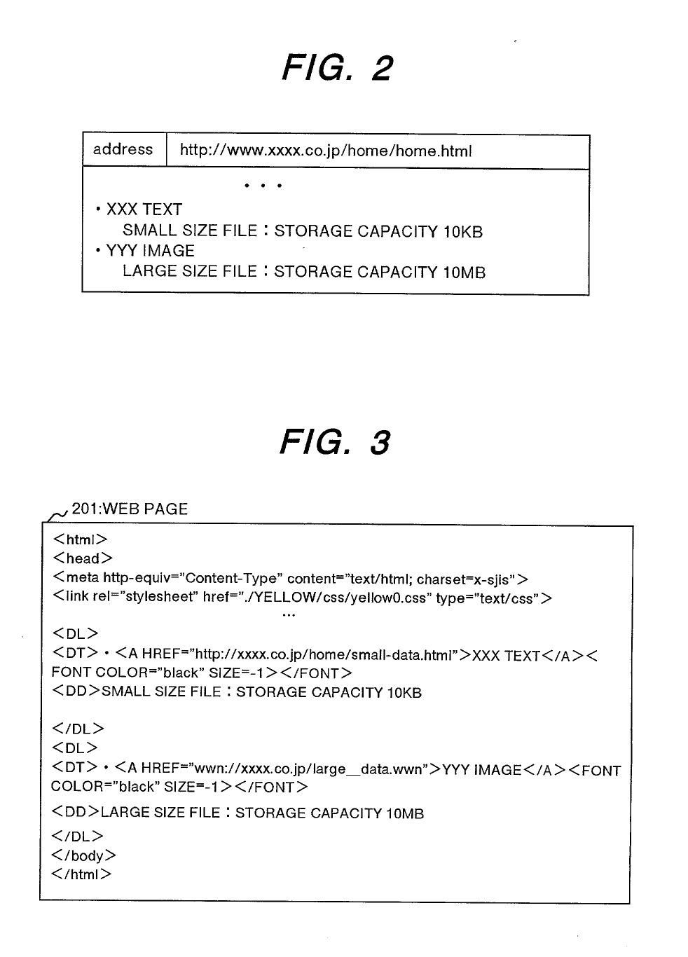

FIG. 2 is an example of the Web page 201 that the browser 105 displays on a display device of the computer 104. On the Web page, there are displayed names and attributes of two files, namely the XXX text 202 and the YYY image 203, which the user can specify for viewing. The XXX text 202 is a small capacity file that occupies a storage capacity of 10 KB, and the YYY image 203 is a large capacity file that occupies a storage capacity of 10 MB.

FIG. 3 is an example of data of the Web page 201 in HTML file format. On the Web page 201, there are described links to two files, namely the XXX text 202 and the YYY image 203, which the user can specify. The data address of the XXX text 202 is “http://xxxx.co.jp/home/small_data.html”, and it indicates that the address conforms to the HTTP protocol. The data address of the YYY image 203 is “wwn://xxxx.co.jp/large_data.wwn”, and it indicates that the address does not conform to the HTTP protocol. “xxxx.co.jp” if is an address of the server, i.e., the computer 107.

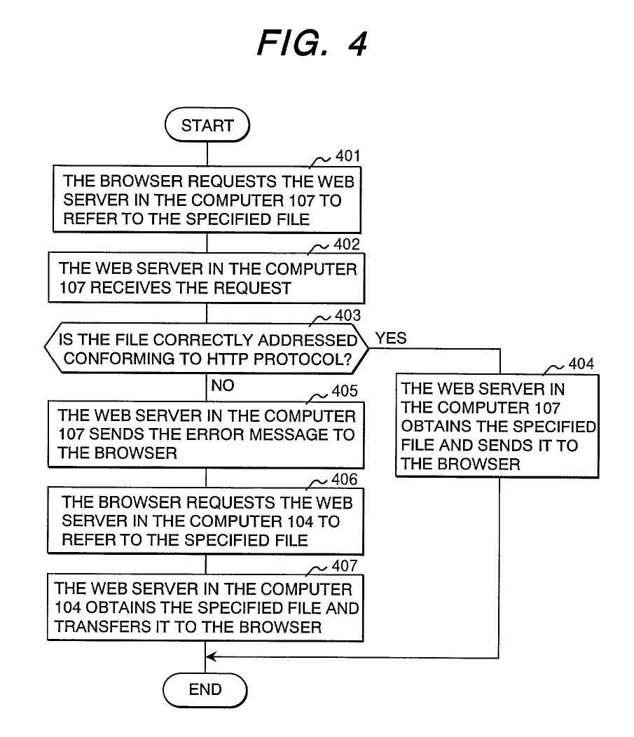

FIG. 4 is a flowchart showing a flow of process performed by the browser 105, the Web server 108 and the Web server 106 of the first embodiment, wherein a user specifies a file via the Web page 201 displayed on the screen and the browser 105 obtains the file. When the user specifies a data address of either one of the XXX text 202 or the YYY image 203 using an input device of the computer 104, the browser 105 sends the data address to the computer 107 over the Internet 101 to request the specified file (Step 401). The Web server 108 of the computer 107 receives the request (Step 402) and judges whether or not the address of the data conforms to the HTTP protocol (Step 403). In the case where the data address is the one that can be interpreted according to the HTTP protocol (Yes in Step 403) such as, for example, the address of the XXX text 202, the Web server 108 accesses and obtains the XXX text 202 on the disk storage 109 to send the XXX text 202 to the browser 105 of the computer 104 over the Internet 101 (Step 404). The browser 105 displays the XXX text 202 on the display device of the computer 104.

In the case where the data address is the one that cannot be interpreted according to the HTTP protocol (No in Step 403) such as, for example, the address of the YYY image 203, the Web server 108 sends an error message indicating that the error is caused by an address that cannot be interpreted to the browser 105 over the Internet 101 (Step 405). The browser 105 sends the data address to the Web server 106 to request the specified file (Step 406). The Web server 106 accesses and obtains the YYY image 203 on the disk storage 110 over the SAN 111 to send the YYY image 203 to the browser 105 (Step 407). The Web server 106 accesses the YYY image 203 by converting the data address received thereby into LUN (Logical Unit Number) and a block number by referring to a management table not shown and issues a read command to the disk storage so as to read the YYY image 203. The YYY image 203 is then sent to the browser 105 from the Web server 106, and the browser displays the YYY image 203 on the display device of the computer 104.

According to the first embodiment, it is possible to access the YYY image 203 over the SAN 111 without changing the existing browser 105 and the Web server 108 or with a minimum change in the browser 105.

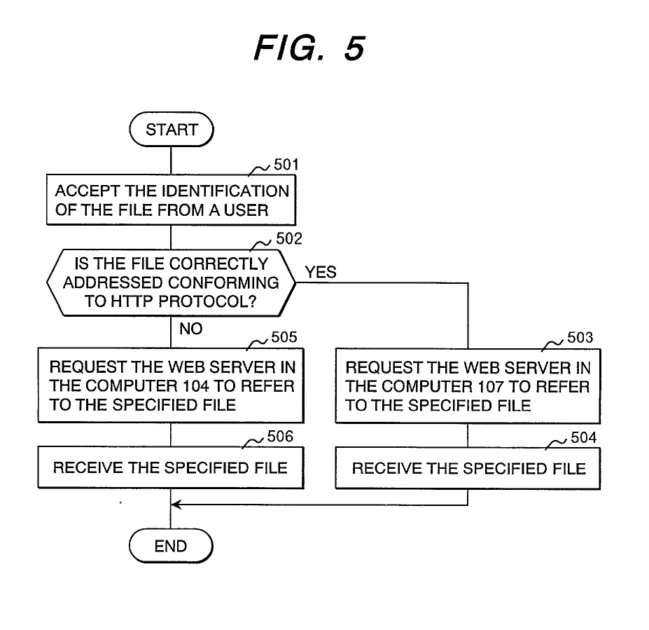

FIG. 5 is a flowchart showing a flow of process of the browser 105 of the second embodiment. The browser 105 receives a data address of either the XXX text 202 or the YYY image 203 (Step 501) and judges whether or not the requested data address conforms to the HTTP protocol (Step 502). In the case where the data address can be interpreted according to the HTTP protocol (Yes in Step 502), the browser 105 requests to the Web server 108 of the computer 107 for the specified file over the Internet 101 (Step 503) and receives the specified file from the Web server 108 (Step 504) to display the same.

In the case where the data address cannot be interpreted according to the HTTP protocol (No in Step 502), the browser 105 requests to the Web server 106 for the specified file (Step 505). The Web server 106 accesses and obtains the YYY image 203 on the disk storage 110 over the SAN 111 to send the YYY image 203 to the browser 105 in the same manner as in Step 407. The browser 105 receives the specified file from the Web server 106 (Step 506) and displays the same.

According to the second embodiment, although it is necessary to change the existing browser 105, it is possible to improve the performance by eliminating the processes of Steps 402 and 405 of the first embodiment and communication over the Internet 101 for sending the error message in the case where the requested data cannot be interpreted according to the HTTP protocol.

According to the present invention as described above, it is possible to achieve a high-speed transfer of a large capacity file over a storage network, for example, by using the Internet and the storage network in combination and selecting one of the networks as a network to be used depending on requested data.

While this invention has been described in conjunction with preferred embodiments thereof, it is evident that many alternatives, modifications and variations will be apparent to those skilled in the art.

What is claimed is:

1. A method for referring to data over a network comprising the steps of:
requesting data over the Internet by specifying a data address;
receiving an error message indicating that the data address cannot be interpreted;
requesting said data over a network between a storage and a computer by specifying said data address; and
receiving said data requested.

2. A method for referring to data to be executed by a computer after receiving an error message indicating that a data address of data requested over the Internet cannot be interpreted, the method comprising the steps of:
requesting said data over a network between a storage and a computer; and
receiving said data requested.

3. A method for referring to data over a network comprising the steps of:
judging whether or not requested data are accessible over the Internet from a data address of the data;
obtaining the requested data over the Internet if it is judged that the data are accessible over the Internet;
requesting said data over a network between a storage and a computer if it is judged that the data are not accessible over the Internet; and
receiving said data requested.

4. A system for referring to data over a network comprising client means and server means, wherein
the client means comprises:
means for requesting data over the Internet by specifying a data address; and
means for receiving an error message indicating that the data address cannot be interpreted, and
the server means comprises:
means for requesting said data over a network between a storage and a computer by specifying said data address; and
means for receiving said data requested.

5. A system for referring to data over a network comprising client means and server means, wherein
the client means comprises:
means for judging whether or not requested data are accessible over the Internet from a data address of the data; and
means for obtaining the requested data over the Internet if it is judged that the data are accessible over the Internet, and
the server means comprises:
means for requesting said data over a network between a storage and a computer if it is judged that said data are not accessible over the Internet; and
means for receiving said data requested.
